(19) United States
(12) Patent Application Publication
(10) Pub. No.: US 2019/0299508 A1
(43) Pub. Date: Oct. 3, 2019

(54) MOLD AND USING METHOD THEREOF

(71) Applicant: PEGATRON CORPORATION, Taipei City (TW)

(72) Inventors: Hsiang-Chi Hsu, Taipei City (TW); Chan-Wei Kuo, Taipei City (TW); Wei-Lin Wu, Taipei City (TW); I-Tien Hsieh, Taipei City (TW); Ho-Ching Huang, Taipei City (TW)

(73) Assignee: PEGATRON CORPORATION, Taipei City (TW)

(21) Appl. No.: 16/368,502

(22) Filed: Mar. 28, 2019

(30) Foreign Application Priority Data
Mar. 30, 2018 (TW) 107111085

(51) Int. Cl. B29C 45/36

(52) U.S. Cl. CPC B29C 45/36; B29C 2045/363

(57) ABSTRACT

A mold adapted to manufacture a first molding element and a second molding element in different shapes or sizes is provided. The mold includes a first mold core, a second mold core and a filling component. The second mold core is capable of being arranged at the first mold core or separated from the first mold core. When the second mold core is arranged at the first mold core, a first mold cavity is formed between the first and second mold cores, and the shape of the first mold cavity corresponds to that of the first molding element. The filling component is detachably arranged in a local region of the first mold cavity. When the second mold core is arranged at the first mold core and the filling component is arranged in the first mold cavity, a second cavity is formed between the first mold core, the second mold core and the filling component, and the shape of the second mold cavity corresponds to that of the second molding element. In addition, a method of using a mold is also provided.

### CROSS-REFERENCE TO RELATED APPLICATION

This application claims the priority benefit of Taiwan application serial no. 107111085, filed on Mar. 30, 2018. The entirety of the above-mentioned patent application is hereby incorporated by reference herein and made a part of this specification.

### BACKGROUND

### 1. Technology Field

The present invention relates to a mold and a using method thereof.

### 2. Description of Related Art

In generally, a set of mold is required to produce a product, and another set of mold is required to produce another product. However, production cost of a mold is high. Therefore, when it is required to manufacture multiple sets of molds to produce various products, high manufacturing cost is needed.

### SUMMARY OF THE INVENTION

The present invention provides a mold, which may be used to manufacture different molding elements.

The present invention provides a method of using a mold, which is applied to the mold.

An embodiment of the present invention provides a mold, which is adapted to manufacture a first molding element and a second molding element in different shapes or sizes. The mold includes a first mold core, a second mold core and a filling component. The second mold core is capable of being arranged at the first mold core or separated from the first mold core. When the second mold core is arranged at the first mold core, a first mold cavity is formed between the first mold core and the second mold core, and the shape of the first mold cavity corresponds to that of the first molding element. The filling component is detachably arranged in a local region of the first mold cavity. When the second mold core is arranged at the first mold core and the filling component is arranged in the first mold cavity, a second cavity is formed between the first mold core, the second mold core and the filling component, and the shape of the second mold cavity corresponds to that of the second molding element.

In an embodiment of the present invention, the first mold core includes a main body and a first shaping element, the main body has a hole, the hole is selectively filled with the first shaping element, and when the first shaping element is arranged in the hole, the first shaping element has a first shaping surface exposed from the hole.

In an embodiment of the present invention, the first mold core further includes a second shaping element, a contour of a second shaping surface of the second shaping element is different from a contour of the first shaping surface of the first shaping element, and the hole is selectively filled with the second shaping element replacing the first shaping element to change a local contour of the first mold cavity or the second mold cavity.

In an embodiment of the present invention, the filling component is a single filling element in contact with both of the first mold core and the second mold core, or, the filling component includes a first filling element and a second filling element, the second filling element corresponds to the first filling element, and corresponding positions in the first mold core and the second mold core are filled with the first filling element and the second filling element respectively.

In an embodiment of the present invention, the first mold cavity and the second mold cavity are different in at least one of width and length.

An embodiment of the present invention provides a method of using a mold, which is adapted to manufacture a first molding element and second molding element in different shapes or sizes. The method of using the mold includes: providing a first mold core and a second mold core corresponding to the first mold core, wherein when the second mold core is arranged at the first mold core, a first mold cavity is formed between the first mold core and the second mold core, and the shape of the first mold cavity corresponds to that of the first molding element; and selectively arranging the second mold core at the first mold core in a first using mode or a second using mode, wherein in the first using mode, the first mold cavity is formed between the first mold core and the second mold core, so that the first molding element is adapted to be manufactured; and in the second using mode, a filling component is arranged in a local region of the first mold cavity to form a second mold cavity between the first mold core, the second mold core and the filling component, and the shape of the second mold cavity corresponds to that of the second molding element, so that the second molding element is adapted to be manufactured.

In an embodiment of the present invention, the first mold core includes a main body and a first shaping element, the main body has a hole, the hole is selectively filled with the first shaping element, and when the first shaping element is arranged in the hole, the first shaping element has a first shaping surface exposed from the hole.

In an embodiment of the present invention, the method of using the mold further includes: finely adjusting an inner contour of the first mold core, wherein the first mold core further includes a second shaping element, a contour of a second shaping surface of the second shaping element is different from a contour of the first shaping surface of the first shaping element, and the second shaping element is selectively arranged in the hole instead of the first shaping element to change a local contour of the first mold cavity or the second mold cavity.

In an embodiment of the present invention, the filling component is a single filling element in contact with both of the first mold core and the second mold core, or, the filling component includes a first filling element and a second filling element, the second filling element corresponds to the first filling element, and corresponding positions in the first mold core and the second mold core are filled with the first filling element and the second filling element respectively.

In an embodiment of the present invention, the first mold cavity and the second mold cavity are different in at least one of width and length.

Based on the foregoing, the filling component of the mold of the embodiment of the present invention is detachably arranged in the local region in the first mold cavity and therefore the first using mode or the second using mode may be selectively executed to manufacture the first molding element or second molding element in different shapes or sizes. In such a manner, different molding elements in different shapes or sizes may be produced without multiple sets of molds, and the cost of manufacturing other sets of molds may be saved.

In order to make the aforementioned features and advantages of the present invention comprehensible, embodiments accompanied with the accompanying drawings are described in detail below.

### BRIEF DESCRIPTION OF THE DRAWINGS

FIG. 1 is a sectional view of a mold in a first using mode according to an embodiment of the present invention.

FIG. 2A is a schematic bottom view of a first mold core and a first mold base in FIG. 1.

FIG. 2B is a schematic top view of a second mold core and a second mold base in FIG. 1.

FIG. 3 is a schematic sectional view of the mold in FIG. 1 in a second using mode.

FIG. 4A is a schematic bottom view of the first mold core and the first mold base in FIG. 3.

FIG. 4B is a schematic top view of the second mold core, a filling component and the second mold base in FIG. 3.

FIG. 5 is a schematic sectional view of the mold in another form in FIG. 1 in the second using mode.

FIG. 6 is a schematic sectional view of a mold according to another embodiment of the present invention in a second using mode.

FIG. 7A and FIG. 7B are schematic diagrams of a first molding element and second molding element manufactured by a mold according to an embodiment of the present invention.

### DETAILED DESCRIPTION

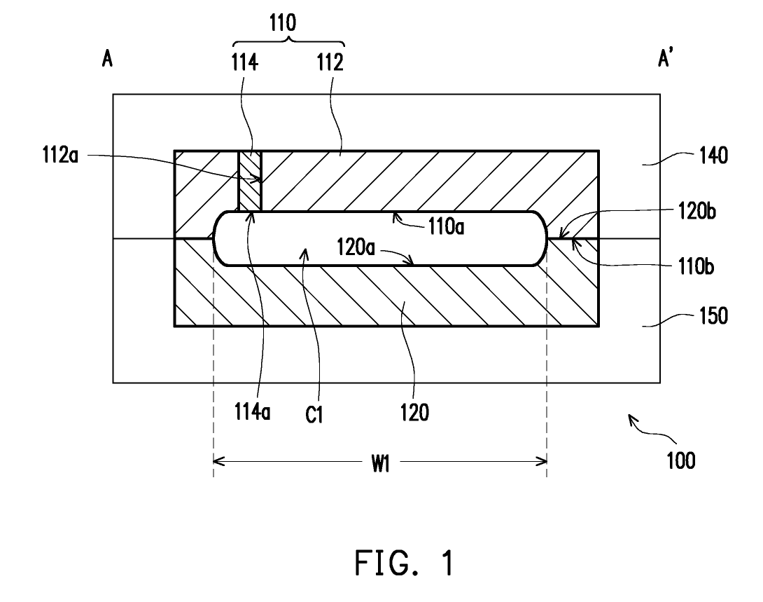

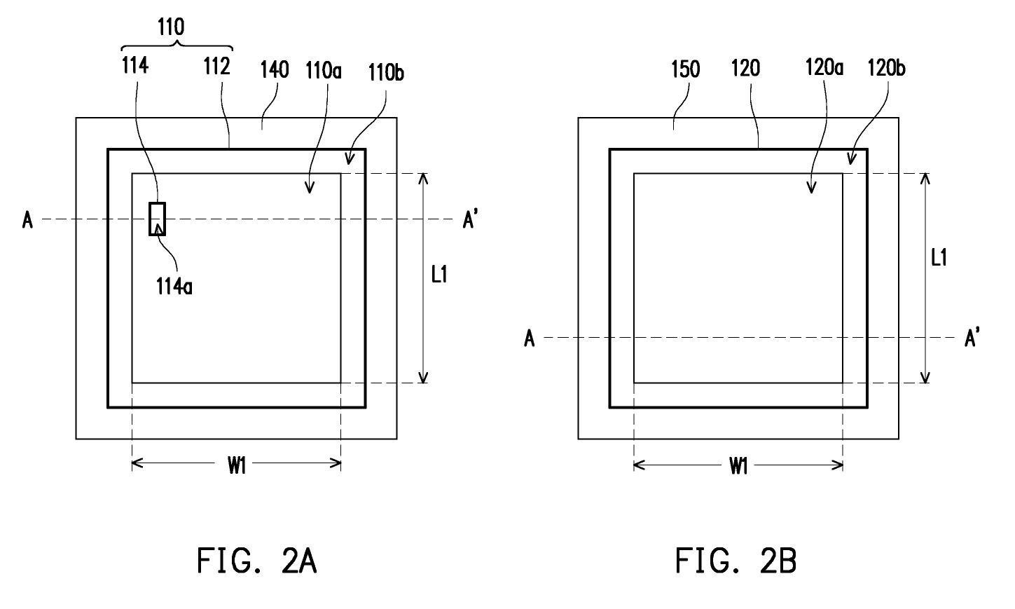

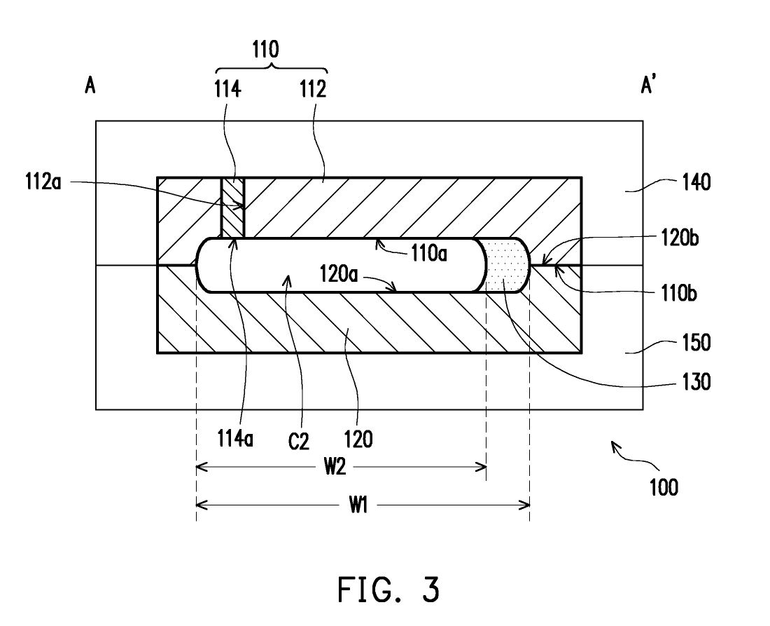

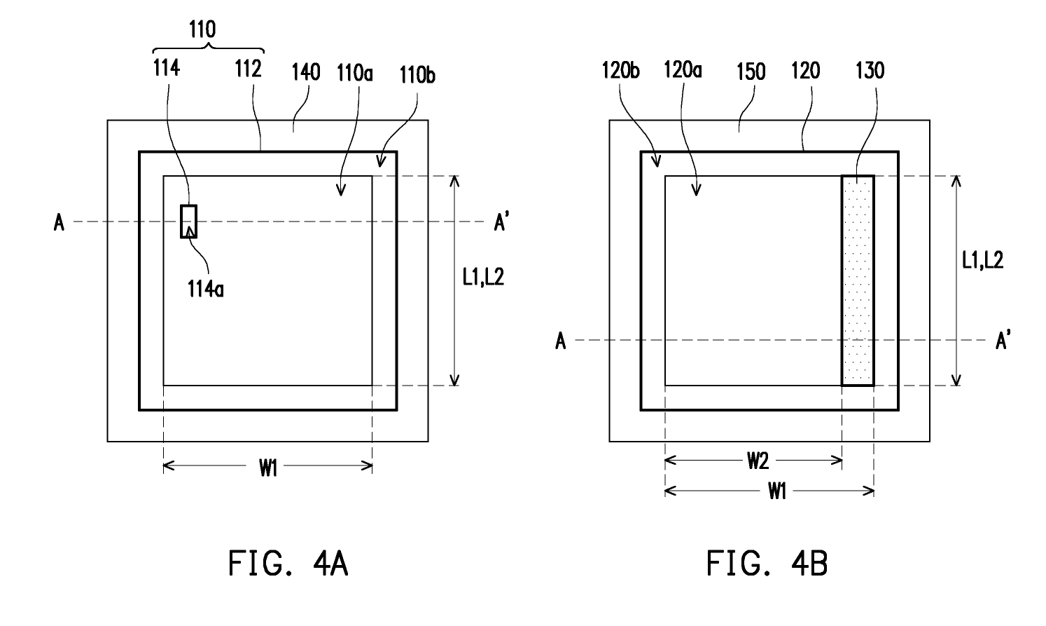

FIG. 1 is a schematic sectional view of a mold according to an embodiment of the present invention in a first using mode. FIG. 2A is a schematic bottom view of the first mold core and a first mold base in FIG. 1. FIG. 2B is a schematic top view of a second mold core and a second mold base in FIG. 1. FIG. 3 is a schematic sectional view of the mold in FIG. 1 in a second using mode. FIG. 4A is a schematic bottom view of the first mold core and the first mold base in FIG. 3. FIG. 4B is a schematic top view of the second mold core, a filling component and the second mold base in FIG. 3. Herein, FIG. 1 corresponds to a section along a line A-A′ in FIG. 2A and FIG. 2B, and FIG. 3 corresponds to a section along a line A-A′ in FIG. 4A and FIG. 4B. For clear illustration, FIG. 1 to FIG. 4B and subsequent related figures are simple schematic diagrams and not intended to limit an actual appearance of the mold.

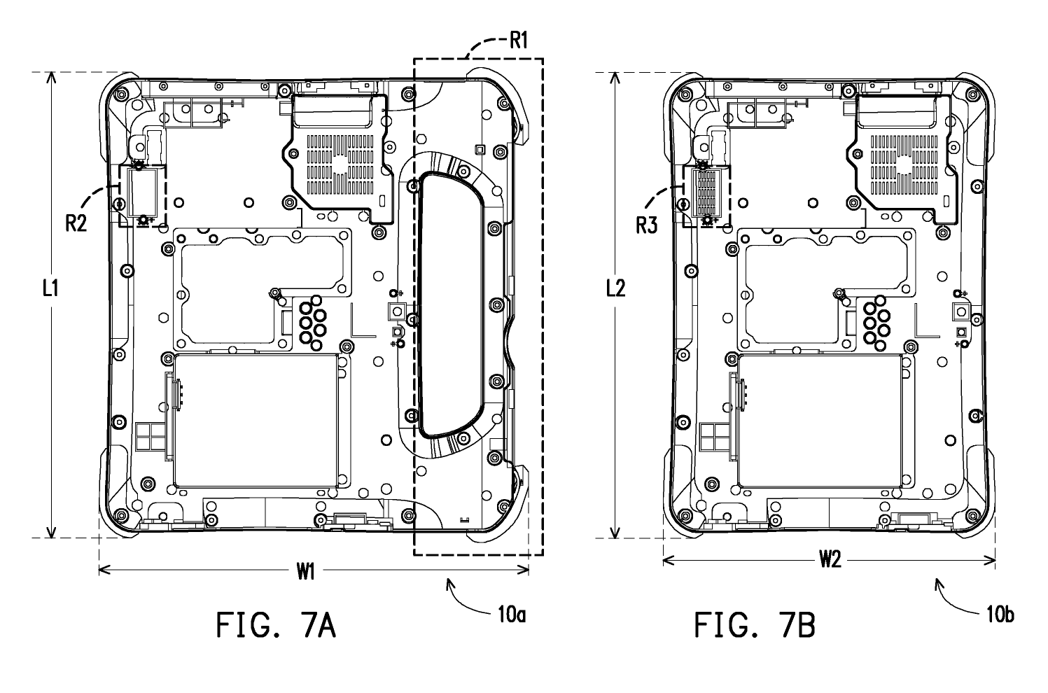

Referring to FIG. 1 to FIG. 4B, a mold 100 of the present embodiment is adapted to manufacture a first molding element (for example, a first molding element 10a in FIG. 7A) and a second molding element (for example, a second molding element 10b in FIG. 7B) in different shapes or sizes. The mold 100 includes a first mold core 110, a second mold core 120 and a filling component 130 (indicated in FIG. 3 and FIG. 4B). The second mold core 120 is capable of being arranged at the first mold core 110 or separated from the first mold core 110. The filling component 130 is detachably arranged in a local region of a first mold cavity C1.

In the present embodiment, the first mold core 110 may have a first bottom surface 110a and a first joint surface 110b, and the second mold core 120 may have a second bottom surface 120a and a second joint surface 120b. The first bottom surface 110a of the first mold core 110 and the second bottom surface 120a of the second mold core 120 correspond to upper and lower surfaces of the first molding element respectively. When the second mold core 120 is arranged at the first mold core 110, the first joint surface 110b is adapted to be jointed to the second joint surface 120b.

In a first using mode, as shown in FIG. 1, when the second mold core 120 is arranged at the first mold core 110, the first mold cavity C1 is formed between the first mold core 110 and the second mold core 120, and the shape of the first mold cavity C1 corresponds to that of the first molding element (for example, the first molding element 10a in FIG. 7A).

In a second using mode, as shown in FIG. 3, when the second mold core 120 is arranged at the first mold core 110 and the filling component 130 is arranged in the first mold cavity C1, a second mold cavity C2 is formed between the first mold core 110, the second mold core 120 and the filling component 130, and the shape of the second mold cavity C2 corresponds to that of the second molding element (for example, the second molding element 10b in FIG. 7B).

Therefore, the mold 100 of the present embodiment is adapted to manufacture the first molding element in the first using mode and adapted to manufacture the second molding element in the second using mode. Then, the first using mode or the second using mode may be selectively executed to manufacture the two molding elements in different shapes or sizes by use of the mold 100 of the present invention without using two sets of molds, so that the cost of manufacturing another set of mold may be saved.

In addition, the mold 100 of the present embodiment may further include a first mold base 140 and second mold base 150 which are bases of the first mold core 110 and the second mold core 120 respectively. The first mold core 110 is adapted to be arranged at the first mold base 140 and the second mold core 120 is adapted to be arranged at the second mold base 150.

In the present embodiment, the first mold cavity C1 and the second mold cavity C2 are different in at least one of width and length. Specifically, the first mold cavity C1 has a first width W1 and a first length L1, and the second mold cavity C2 has a second width W2 and a second length L2, wherein the first width W1 is different from the second width W2, and the first length L1 is the same as the second length L2. However, in another embodiment, the first width W1 may be the same as the second width W2, and the first length L1 may be different from the second length L2. Alternatively, the first width W1 may be different from the second width W2, and the first length L1 may also be different from the second length L2.

In addition, the first mold core 110 includes a main body 112 and a first shaping element 114, the main body 112 has a hole 112a. The hole 112a may be selectively filled with the first shaping element 114, and when the first shaping element 114 is arranged in the hole 112a, the first shaping element 114 has a first shaping surface 114a exposed from the hole 112a. In another embodiment, the second mold core 120 may include a main body and a first shaping element, or each of the first mold core 110 and the second mold core 120 includes a main body and a first shaping element. The present invention is not limited thereto. Herein, a contour of the first shaping surface 114a in FIG. 1 is only simply illustrated and not intended to limit an actual contour of the first shaping surface 114a, and the first shaping surface 114a may have various bumpy contours.

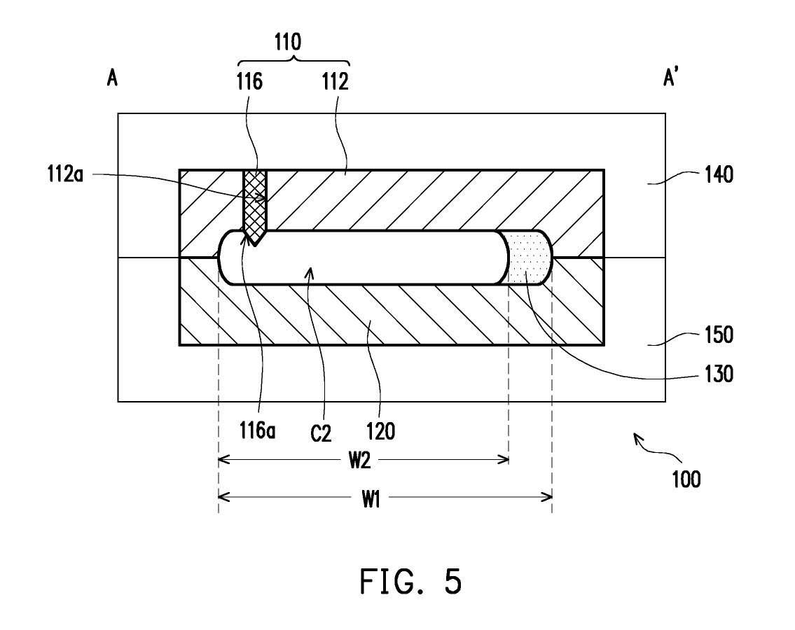

FIG. 5 is a schematic sectional view of the mold in another form in FIG. 1 in the second using mode. Referring to FIG. 5, the first mold core 110 further includes a second shaping element 116, a contour of a second shaping surface 116a of the second shaping element 116 is different from the contour of the first shaping surface 114a of the first shaping element 114, and the hole 112a is selectively filled with the second shaping element 116 instead of the first shaping element 114 to change a local contour of the first mold cavity C1 or the second mold cavity C2 (for example, the local contour of the second mold cavity C2 is changed in FIG. 5). That is, the shaping elements having the shaping surfaces with different contours may be arranged in the hole 112a to finely modify the inner contour of the first mold core 110 to manufacture molding elements with different contours without using multiple sets of molds, so that mold manufacturing cost may be saved.

Specifically, according to the mold 100 of the present invention, the filling component 130 is arranged in the first mold cavity C1 to produce the second molding element different from the first molding element, and the inner contour of the first mold core 110 is finely modified by use of different shaping elements. Therefore, except the local region where the filling component 130 is arranged, the first molding element and the second molding element have similar contours. That is, the mold 100 of the embodiment of the present invention is adapted to produce various molding elements with the same or similar local contours.

Based on the foregoing, according to the mold 100 of the present embodiment, the contour of the mold cavity formed in the mold 100 is changed in two manners. In the first manner, the first mold cavity C1 is filled with the filling component 130 to form the second mold cavity C2. In the second manner, the second shaping element 116 replaces the first shaping element 114 arranged in the hole 112a to change the local contour of the first mold cavity C1 or the second mold cavity C2. In the two manners, the contour of the mold cavity formed in the mold 100 may be changed. Therefore, according to the mold 100 of the present embodiment, multiple molding elements in different shapes or sizes may be manufactured by use of a single set of mold, and the mold manufacturing cost may be saved.

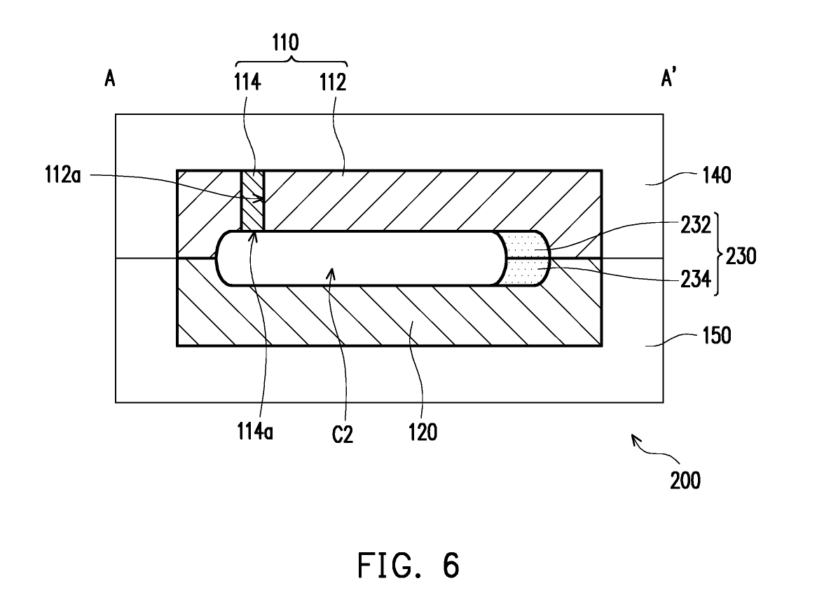

FIG. 6 is a schematic sectional view of a mold according to another embodiment of the present invention in a second using mode. Referring to FIG. 6, a mold 200 of the present embodiment is similar to the mold 100. A main difference is that the filling component 130 of the mold 100 is a single filling element in contact with both of the first mold core 110 and the second mold core 120 while a filling component 230 of the mold 200 of the present embodiment includes a first filling element 232 and a second filling element 234. The second filling element 234 corresponds to the first filling element 232, and corresponding positions in the first mold core 110 and the second mold core 120 are filled with the first filling element 232 and the second filling element 234 respectively. However, in another embodiment, the filling component 130 or the filling component 230 may include another number of filling elements or have another form. The present invention is not limited thereto.

FIG. 7A and FIG. 7B are schematic diagrams of a first molding element and second molding element manufactured by a mold according to an embodiment of the present invention. Referring to FIG. 7A and FIG. 7B, for example, the first molding element 10a in FIG. 7A may be manufactured by use of the mold 100 with the first mold cavity C1 in the first using mode in FIG. 1, and the second molding element 10b in FIG. 7B may be manufactured by use of the mold 100 with the second mold cavity C2 in the second using mode in FIG. 5. The first molding element 10a has the first width W1 and first length L1 corresponding to the first mold cavity C1, and the second molding element 10b has the second width W2 and second length L2 corresponding to the second mold cavity C2. Herein, the first width W1 is different from the second width W2, and the first length L1 is the same as the second length L2.

Herein, a region R1 of the first molding element 10a is equivalent to the position of the filling component 130 in FIG. 5, so that the second molding element 10b does not have the region R1 of the first molding element 10a. In addition, a region R2 of the first molding element 10a is equivalent to the position of the first shaping element 114 in FIG. 1, and a region R3 of the second molding element 10b is equivalent to the position of the second shaping element 116 in FIG. 5, so the region R2 of the first molding element 10a may have a different contour from the region R3 of the second molding element 10b. That is, by means of filling with the filling component 130 or selectively filling with first shaping element 114 or second shaping element 116, multiple molding elements in different shapes or sizes may be manufactured by use of the single set of mold of the embodiment of the present invention, and the cost of manufacturing other sets of molds may be saved.

Based on the foregoing, the filling component of the mold of the embodiment of the present invention is detachably arranged in the local region in the first mold cavity, and therefore the first using mode or the second using mode may be selectively executed to manufacture the first molding element or the second molding element in different shapes or sizes. In such a manner, different molding elements in different shapes or sizes may be produced without multiple sets of molds, and the cost of manufacturing molds may be saved.

Although the embodiments of the present invention have been disclosed as above, they are not intended to limit the present invention. Those of ordinary skill in the art may make some modifications and embellishments without departing from the spirit and scope of the present invention. Therefore, the scope of protection of the present invention should be subject to the appended claims.

What is claimed is:

1. A mold, adapted to manufacture a first molding element and a second molding element in different shapes or sizes, the mold comprising:
a first mold core;
a second mold core, capable of being arranged at the first mold core or separated from the first mold core, wherein when the second mold core is arranged at the first mold core, a first mold cavity is formed between the first mold core and the second mold core, and the shape of the first mold cavity corresponds to that of the first molding element; and
a filling component, detachably arranged in a local region of the first mold cavity, wherein when the second mold core is arranged at the first mold core and the filling component is arranged in the first mold cavity, a second cavity is formed between the first mold core, the second mold core and the filling component, and the shape of the second mold cavity corresponds to that of the second molding element.

2. The mold according to claim 1, wherein the first mold core comprises a main body and a first shaping element, the main body has a hole, the hole is selectively filled with the first shaping element, and when the first shaping element is arranged in the hole, the first shaping element has a first shaping surface exposed from the hole.

3. The mold according to claim 2, wherein the first mold core further comprises a second shaping element, a contour of a second shaping surface of the second shaping element is different from a contour of the first shaping surface of the first shaping element, and the hole is selectively filled with the second shaping element replacing the first shaping element to change a local contour of the first mold cavity or the second mold cavity.

4. The mold according to claim 1, wherein the filling component is a single filling element in contact with both of the first mold core and the second mold core, or, the filling component comprises a first filling element and a second filling element, the second filling element corresponds to the first filling element, and corresponding positions in the first mold core and the second mold core are filled with the first filling element and the second filling element respectively.

5. The mold according to claim 1, wherein the first mold cavity and the second mold cavity are different in at least one of width and length.

6. A method of using a mold, adapted to manufacture a first molding element and second molding element in different shapes or sizes, the method of using the mold comprising:
providing a first mold core and a second mold core corresponding to the first mold core, wherein when the second mold core is arranged at the first mold core, a first mold cavity is formed between the first mold core and the second mold core, and the shape of the first mold cavity corresponds to that of the first molding element; and
selectively arranging the second mold core at the first mold core in a first using mode or a second using mode, wherein in the first using mode, the first mold cavity is formed between the first mold core and the second mold core, so that the first molding element is adapted to be manufactured; and in the second using mode, a filling component is arranged in a local region of the first mold cavity to form a second mold cavity between the first mold core, the second mold core and the filling component, and the shape of the second mold cavity corresponds to that of the second molding element, so that the second molding element is adapted to be manufactured.

7. The method of using the mold according to claim 6, wherein the first mold core comprises a main body and a first shaping element, the main body has a hole, the hole is selectively filled with the first shaping element, and when the first shaping element is arranged in the hole, the first shaping element has a first shaping surface exposed from the hole.

8. The method of using the mold according to claim 7, further comprising:
finely adjusting an inner contour of the first mold core, wherein the first mold core further comprises a second shaping element, a contour of a second shaping surface of the second shaping element is different from a contour of the first shaping surface of the first shaping element, and the second shaping element is selectively arranged in the hole instead of the first shaping element to change a local contour of the first mold cavity or the second mold cavity.

9. The method of using the mold according to claim 6, wherein the filling component is a single filling element in contact with both of the first mold core and the second mold core, or, the filling component comprises a first filling element and a second filling element, the second filling element corresponds to the first filling element, and corresponding positions in the first mold core and the second mold core are filled with the first filling element and the second filling element respectively.

10. The method of using the mold according to claim 6, wherein the first mold cavity and the second mold cavity are different in at least one of width and length.
